(19) United States
(12) Patent Application Publication
(10) Pub. No.: US 2017/0200041 A1
(43) Pub. Date: Jul. 13, 2017

(54) MULTI-MODAL DATA AND CLASS CONFUSION: APPLICATION IN WATER MONITORING

(71) Applicant: Regents of the University of Minnesota, Minneapolis, MN (US)

(72) Inventors: Vipin Kumar, Minneapolis, MN (US); Anuj Karpatne, Minneapolis, MN (US)

(21) Appl. No.: 15/403,708

(22) Filed: Jan. 11, 2017

Related U.S. Application Data
(60) Provisional application No. 62/278,182, filed on Jan. 13, 2016.

(51) Int. Cl. G06K 9/00; H04N 7/18; G06K 9/48; G06K 9/46; G06K 9/62

(52) U.S. Cl. CPC G06K 9/0063; G06K 9/4671; G06K 9/6277; G06K 9/6218; G06K 9/481; H04N 7/181; G06T 2200/24

(57) ABSTRACT

A system includes an aerial image database containing sensor data representing an aerial image of the earth surface, the sensor data comprising a feature vector for each pixel in the aerial image. A processor applies a plurality of classifiers to each feature vector to produce a plurality of classifier scores for each feature vector. The processor then determines a plurality of cluster probabilities for each feature vector, each cluster probability for a feature vector indicating a probability of the feature vector given a respective cluster of feature vectors. The processor uses the cluster probabilities for the feature vectors to form a respective weight for each of the plurality of classifiers. The processor combines the weights and the classifier scores to form an ensemble score for each pixel, the ensemble score indicating which of two possible land cover types is present on a portion of the earth surface represented by the pixel.

### CROSS-REFERENCE TO RELATED APPLICATION

The present application is based on and claims the benefit of U.S. provisional patent application Ser. No. 62/278,182, filed Jan. 13, 2016, the content of which is hereby incorporated by reference in its entirety.

This invention was made with government support under 1029711 and 0905581 awarded by the National Science Foundation (NSF) and NNX12AP37G awarded by National Aeronautics and Space Administration (NASA). The government has certain rights in the invention.

### BACKGROUND

Aerial and satellite photographs of the Earth are used to determine what parts of the Earth are covered by water and what parts are covered by land. Because the photographs are collected at high altitudes, the difference between land and water is not always apparent in the photographs. As a result, both people and computers struggle to correctly classify each pixel in each photograph. In particular, the operation of computers during such classification is inadequate and needs to be improved.

### SUMMARY

A system includes an aerial image database containing sensor data representing an aerial image of the earth surface, the sensor data comprising a feature vector for each pixel in the aerial image. A processor applies a plurality of classifiers to each feature vector to produce a plurality of classifier scores for each feature vector. The processor then determines a plurality of cluster probabilities for each feature vector, each cluster probability for a feature vector indicating a probability of the feature vector given a respective cluster of feature vectors. The processor uses the cluster probabilities for the feature vectors to form a respective weight for each of the plurality of classifiers. The processor combines the weights and the classifier scores to form an ensemble score for each pixel, the ensemble score indicating which of two possible land cover types is present on a portion of the earth surface represented by the pixel.

In accordance with a further embodiment, a method includes retrieving from memory, features for a set of pixels, each pixel representing an image of a geographic area. Each pixel's features are classified using a plurality of different classifiers to generate a plurality of classifier scores for each pixel's features. A weight is determined for each classifier score for each pixel based on similarities between the pixel's features and features used to train the respective classifier that generated the classifier score. Each weight is applied to the weight's respective classifier score to form a weighted score and the weighted scores are combined to determine an ensemble score for each pixel. The ensemble score for each pixel is then used to designated the geographic area represented by the pixel as being one of two land cover types.

A computer-readable storage device having stored thereon computer-executable instructions that when executed by a processor cause the processor to perform steps. The steps include for each pixel in an image of a geographic area, determining a plurality of classifier scores, each classifier score indicative of whether the pixel represents a first land cover type or a second land cover type. Each classifier score is weighted based on a relevance score of a classifier that generated the classifier score, the relevance score indicating the likelihood that the pixel would be part of clusters of pixels that the classifier was trained to discriminate between. The weighted classifier scores are used to produce an ensemble score that is indicative of whether the pixel represents the first land cover type or the second land cover type.

### BRIEF DESCRIPTION OF THE DRAWINGS

FIG. 1 is a schematic illustration of multi-modality within the classes, where each class comprises of three modes.

FIG. 2 is a toy dataset showing multi-modality within the classes, where P₂ and N₂ show class confusion.

FIG. 3 is a synthetic dataset with 10 positive modes: P₁ to P₁₀, and 10 negative modes N₁ to N₁₀, with varying degrees of class confusion among pairs of modes.

FIG. 4 is a graph comparing classification performance on synthetic dataset.

FIG. 5 is a graph comparing the performance of AHEL using varying clustering algorithms.

FIG. 6a is a scatter plot of mean error rates of AHEL and Global across all test scenarios.

FIG. 6b is a scatter plot of mean error rates of AHEL and BOVO across all test scenarios.

FIG. 7a is errors of GLOBAL over L₁.

FIG. 7b is errors of AHEL over L₁.

FIG. 8a is errors of BOVO over L₁.

FIG. 8b is errors of AHEL over L₁.

FIG. 9 provides a block diagram of a system of land cover identification in accordance with one embodiment.

FIG. 10 provides a block diagram of a mobile device.

### DETAILED DESCRIPTION OF ILLUSTRATIVE EMBODIMENTS

The embodiments described below improve the operation of a computer during the task of classifying a pixel in an image as either representing land or water.

### Introduction and Motivation

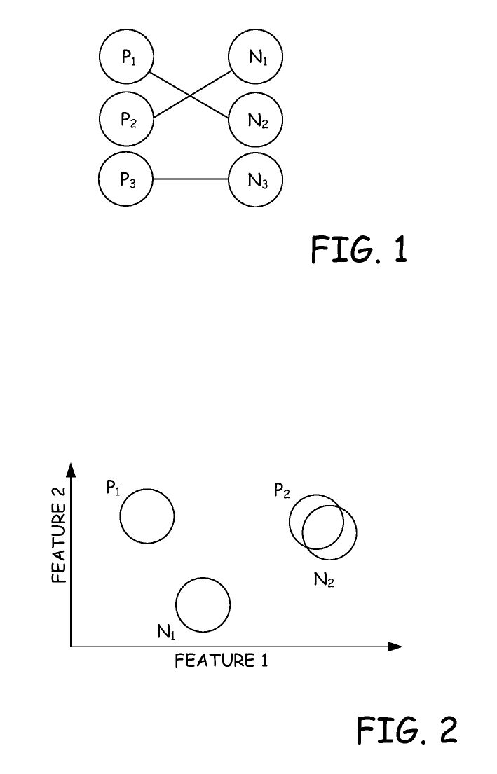

A number of binary classification problems commonly experience heterogeneity within the two classes, which is characterized by the presence of multiple modes of each of the two classes in the feature space. For example, in order to classify locations on the Earth as water or land (binary classes) using remote sensing data (explanatory features), there is a need to account for the variety of water categories (e.g. shallow water, water near swamps, etc.) and land categories (e.g. forests, shrublands, sandy soil, etc.) that exist at a global scale, resulting in a multi-modal distribution of both water and land classes. FIG. 1 shows a schematic illustration of a classification problem involving multiple modes of the positive and negative classes. In such situations, different pairs of positive and negative modes can show varying degrees of overlap in the feature space. This is represented in FIG. 1 as edges with varying thickness, where the thickness of an edge reflects the degree of overlap between the pair of modes. Learning a single classifier that discriminates between all varieties of positive and negative modes is then challenging, especially in the presence of highly overlapping pairs of modes. We denote this phenomena as class confusion and the pair of modes participating in a class confusion as confusing modes in the remainder of the paper.

We consider binary classification problems where the classification has to be performed over different test scenarios, and every test scenario involves only a subset of all the positive and negative modes in the data. As an illustrative example, in the context of classifying locations on the Earth as water or land, a test scenario would comprise of instances observed in the vicinity of the same water body and at the same time-step. In such a setting, different pairs of positive and negative modes may emerge or disappear in different test scenarios, and even though some modes may be participating in class confusion, the subset of modes appearing in a given test scenario can be considered to be locally separable among each other. This shows a promise in using information about the context of a test scenario for overcoming class confusion.

To illustrate the importance of using the local context of a test scenario in the learning of a classifier, consider the toy dataset shown in FIG. 2. This dataset comprises of instances belonging to two classes where each class comprises of two distinct modes, shown as circles in FIG. 2. It can be observed that modes P₁ and N₁ are easily separable in the feature space, whereas modes P₂ and N₂ show class confusion. Assuming that we have access to a training dataset with adequate representation from every mode in the data, let us consider learning pair-wise classifiers, C_{i,j}, to distinguish between every pair of positive and negative modes, Pᵢ and Nⱼ. This would result in an ensemble of classifiers which can then be applied on any unlabeled instance in a test scenario to estimate its class label. Now let us consider a test scenario involving instances from P₁ and N₁, denoted by S_{1,1}. Since P₁ and N₁ are easily separable in the feature space and both P₁ and N₁ do not participate in any class confusion, test instances in S_{1,1} would be correctly labeled even by a single classifier that discriminates between all positive and negative modes.

However, if we consider a test scenario S_{1,2} involving instances from P₁ and N₂, we would notice that even though P₁ and N₂ are easily separable in the feature space, the presence of class confusion between P₂ and N₂ would hamper the classification performance at N₂, since instances belonging to N₂ can be easily misclassified to be belonging to P₂. To overcome this challenge, consider the following simplistic approach: let us assign a relevance score to every pair-wise classifier, C_{i,j}, in accordance with its likelihood of being used in the context of a test scenario. In particular, classifiers that discriminate between modes having a higher likelihood of being observed given the distribution of instances in a test scenario would receive higher relevance scores. Using this approach, we can assign a relevance score to every pair-wise classifier for both test scenarios, S_{1,1} and S_{1,2}, and consider it to be either “Relevant” or “Not Relevant”, as summarized in Table I. For S_{1,1}, the only relevant classifier would then be C_{1,1}, which would correctly label all test instances in S_{1,1}. However, for S_{1,2}, both C_{1,2} and C_{2,2} would be considered as relevant, as the test instances in S_{1,2} would show high likelihood for all the three modes, P₁, P₂, and N₂. However, C_{2,2} would show poor cross-validation accuracy on the training set, since it discriminates between a pair of confusing modes, P₂ and N₂. C_{2,2} could thus be discarded from the set of relevant classifiers, resulting in the only relevant classifier for S_{1,2} to be C_{1,2}. C_{1,2} would then be able to correctly label all test instances in S_{1,2}, and thus avoid class confusion in this particular situation. Note that the ability of the above simplistic scheme in overcoming class confusion arises from the fact that the distribution of test instances belonging to a test scenario contains reasonable information about its local context. We use this property as a guiding principle for motivating our proposed approach.

TABLE I
Table summarizing whether a particular classifier
C_{i, j} is relevant for a particular test scenario or not.

Test Scenario

| Classifier | S_{1, 1} | S_{1, 2} |
|---|---|---|
| C_{1, 1} | “Relevant: | “Not Relevant” |
| C_{1, 2} | “Not Relevant” | “Relevant” |
| C_{2, 1} | “Not Relevant” | “Not Relevant” |
| C_{2, 2} | “Not Relevant” | “Relevant” |

We propose the Adaptive Heterogeneous Ensemble Learning (AHEL) algorithm that takes into account the context of test instances belonging to a test scenario for overcoming class confusion in certain scenarios. We demonstrate the effectiveness of our approach in comparison with baseline approaches on a synthetic dataset and a real-world application involving global water monitoring.

Notations:

Let [symbol] ={(xᵢ,yᵢ)}₁ⁿ denote the training dataset with n labeled instances, where xᵢε [symbol] ^{d} is a d-dimensional feature vector and yᵢε{−1, +1} is its binary response label. Let us assume that this training dataset comprises of n₊ positively labeled instances, denoted by X₊={xᵢ}₁ⁿ⁺, and n₋ negatively labeled instances, denoted by X₋={xᵢ}₁ⁿ⁻. Given this training dataset, our objective is to estimate the binary response, yε{−1,1}, for every test instance, x, belonging to a test scenario, X_{S}={xᵢ}₁^{s}.

We present the Adaptive Heterogeneous Ensemble Learning (AHEL) algorithm that comprises of the following steps:

### A. Learning the Multi-Modality in Training Data:

We assume that our training dataset, D, contains a variety of instances from all possible positive and negative modes in the data, but explicit information about the multi-modal structure of the two classes is not known and needs to be inferred. To achieve this, we consider clustering the training instances belonging to each of the two classes separately. This results in the decomposition of the positive class, X₊, into m₊ clusters or modes and the negative class, X₋, into m₋ clusters or modes, respectively. The choice of the clustering algorithm and the number of clusters, m₊ and m₋, used for representing the multi-modality within the classes depends on the characteristics of the data. For every cluster label c, let X_{c} denote the set of training instances with cluster label c, where c can either be one of the positive cluster labels, P₁ to Pₘ₊, or the negative cluster labels, N₁ to Nₘ₋.

We further consider every cluster label c to have an associated conditional probability distribution, [symbol] (x|c), for every instance xε [symbol] ^{d}. This can either be available as a by-product of the clustering algorithm or can be inferred from the distribution of instances in X_{c}. As an example, we consider [symbol] (x|c) to follow a normal distribution in the feature space with the sample mean, x̅_{c}, as its center and with unit variance, whenever [symbol] (x|c) is not explicitly available during the clustering process. However, it should be noted that the choice of the probability distribution used for representing [symbol] (x|c) depends on the target application and can be acquired via domain knowledge.

### B. Constructing an Ensemble of Classifiers:

We construct an ensemble of classifiers to discriminate between every pair of positive and negative cluster labels in [symbol] , similar in essence to a Bipartite One-vs-One (BOVO) ensemble construction strategy. This ensures adequate representation of every mode in the ensemble construction process, along with maintaining sufficient diversity among the classifiers. This can be contrasted with traditional ensemble learning approaches for binary classification, e.g. bagging, boosting, and random forests, which make use of random partitions of the training data as opposed to using a stratified sampling of the training instances in accordance with the multi-modal structure of the two classes.

For every pair of positive and negative cluster labels, (Pᵢ,Nⱼ), we learn a classifier, fₗ, to discriminate between X_{Pi} and X_{Nj}, using an appropriate choice of the base classifier. This results in the learning of an ensemble of classifiers {f₁, . . . ,f_{m*}}, where m*=m₊×m₋. We further compute the cross-validation accuracy of every classifier, f₁, using 5-fold cross-validation on X_{Pi} and X_{Nj}, and use it as a measure of the accuracy of f₁, denoted by Acc(f₁).

### C. Assigning Adaptive Weights to Classifiers:

For every classifier, fₗ, we assign it a weight, w(fₗ,X_{S}), representing its importance of being used for classification in the context of a test scenario, X_{S}. In particular, we want to assign higher weights to classifiers that discriminate between pairs of modes that have a higher likelihood of being observed, given the distribution of instances in a test scenario, X_{S}. Such a weighting scheme is achieved as follows.

For every test instance x belonging to X_{S}, we compute its probability of being generated from a mode c as P(x|c). We can then assign a relevance score to every mode c, denoted by [symbol] (c, X_{S}), which indicates its likelihood of being observed given the distribution of instances in X_{S}, defined as:

$$( c , {X}_{S} ) = {\sum }_{x ∈ {X}_{s}} 𝒫 ( x \vert c ) \qquad ( 1 )$$

For a classifier, fₗ, that discriminates between Pᵢ and Nⱼ, the relevance of using fₗ in the context of X_{S}, denoted by [symbol] (f₁,X_{S}), depends on the relevance of observing modes Pᵢ and Nⱼ in X_{S}, and can be estimated as:

[symbol]

(f₁,X_{S})= [symbol] (Pᵢ,X_{S})× [symbol] (Nⱼ,Xₛ) (2)

[symbol] (f₁,X_{S}) ensures that classifiers receive high weights only if both the modes involved in learning f₁ have a high likelihood of being observed in X_{S}. Each classifier f₁ is further assigned a score α(f₁), denoting its ability to differentiate between its pair of participating modes. α(f₁) can be computed as:

$$α ( {f}_{l} ) = \{ \begin{matrix}Acc ( {f}_{l} ) , & if Acc ( {f}_{l} ) > 0.6 \\ 0 , & otherwise\end{matrix}$$

The weight of a classifier fₗ in the context of test scenario X_{S} is then estimated as:

w(f₁,X_{S})=α(f₁)× [symbol] (f₁,X_{S}) (3)

To illustrate the usefulness of w(f₁,X_{S}) in choosing the appropriate set of classifiers, especially in the presence of class confusion, consider a test scenario X_{S} that involves instances from P_{c} and N_{nc}, such that P_{c} shows class confusion with some other mode N_{c} not present in X_{S}. In such a situation, P_{c}, N_{c}, and N_{nc} would receive the highest relevance scores in the context of X_{S}. By taking the products of the relevance scores, the two classifiers that would receive the highest relevance scores would then be the ones that separate (P_{c} and N_{c}) and (P_{c} and N_{nc}). On the other hand, none of the pair-wise classifiers separating P_{c}, N_{c}, and N_{nc} from some other mode, O, will have a high relevance score, due to the low relevance score of O. The classifier separating (P_{c} and N_{c}) will eventually receive a low weight owing to its poor cross-validation accuracy and will be discarded. Thus, the classifier separating (P_{c} and N_{nc}) will be appropriately selected with the highest weight, resulting in adequate classification performance even in the presence of class confusion.

Note that our proposed weighting scheme inherently assumes that every test scenario involves a subset of positive and negative modes that are separable among each other but may show class confusion with other modes observed globally that are not present in the current test scenario. It is also assumed that a test scenario involving a confusing mode has instances from both the classes, thus requiring the use of a classifier in the first place. Furthermore, the ability of the above weighting scheme in avoiding class confusion hinges on the presence of at least a single non-confusing mode in the test scenario, which can dominate the assignment of relevance scores to classifiers.

### D. Combining Ensemble Responses:

We apply the ensemble of classifiers on a test instance, xεX_{S}, to obtain a vector of ensemble responses, f(x)=[f₁(x), . . . ,f_{m*}(x)]. For each ensemble response, fₗ(x), we compute its loss w.r.t. a cluster label, c, as follows:

$$Loss ( c , {f}_{l} ) = \{ \begin{matrix}L ( + {f}_{l} ) , & if c = {P}_{i} \\ L ( - {f}_{l} ) , & if c = {N}_{j} \\ 0 , & otherwise\end{matrix}$$

where, Pᵢ and Nⱼ are the positive and negative cluster labels used for learning f₁, and L(z) is an appropriate loss function, e.g. the hinge loss function, L(z)=max[1−z,0}, commonly used with support vector machines (SVMs) as base classifiers. The combined loss of all ensemble response w.r.t a cluster label c is then defined as:

$$Loss ( c , f ( x ) ) = {\sum }_{l = 1}^{{m}^{*}} w ( {f}_{1} , {X}_{S} ) Loss ( c , {f}_{l} ) \qquad ( 4 )$$

We choose ĉ as the cluster label which provides the minimum loss, ĉ=argmin_{c} Loss (c,f(x)). The test instance x is then classified as positive if ĉ is a positive cluster label, otherwise it is classified as negative.

### Experimental Results

We compared the performance of AHEL with the baseline approach of learning a single non-linear classifier, termed as the GLOBAL approach. We also compared our results with the Bipartite One-vs-One (BOVO) ensemble learning approach, which is able to handle heterogeneity within the classes but is unable to adapt its learning using the local context of a test scenario. In order to compare our performance with local learning algorithms, we considered the k-nearest neighbor (KNN) algorithm with k=5 as a baseline approach. Furthermore, in order to emphasize the importance of using the distribution of an entire group of instances belonging to a test scenario as opposed to an individual test instance, we considered a variant of our algorithm that uses instance-specific information for assigning weights to ensemble classifiers, termed as the Instance-specific Heterogeneous Ensemble Learning (IHEL) algorithm. Specifically, IHEL considers the relevance of using a classifier fₗ on a test instance x as [symbol] (f₁,x)=max ( [symbol] (x|Pᵢ), [symbol] (x|Nⱼ)), where fₗ discriminates between Pᵢ and Nⱼ. IHEL thus follows the same formulation as AHEL, except for the fact that it uses [symbol] (f₁,x) in place of [symbol] (f₁,X_{S}).

We used support vector machines (SVMs) with radial basis function (RBF) kernel as the base classifier for the GLOBAL approach and all ensemble learning methods used in this paper. The optimal hyper-parameters of SVM were chosen using 5-fold cross-validation on the training set in every experiment. The number of positive and negative clusters were kept equal in all experiments (m₊=m₋=m). The classification error rate was used as the evaluation metric for comparing the performance of classification algorithms in every experiment.

### A. Results on Synthetic Dataset:

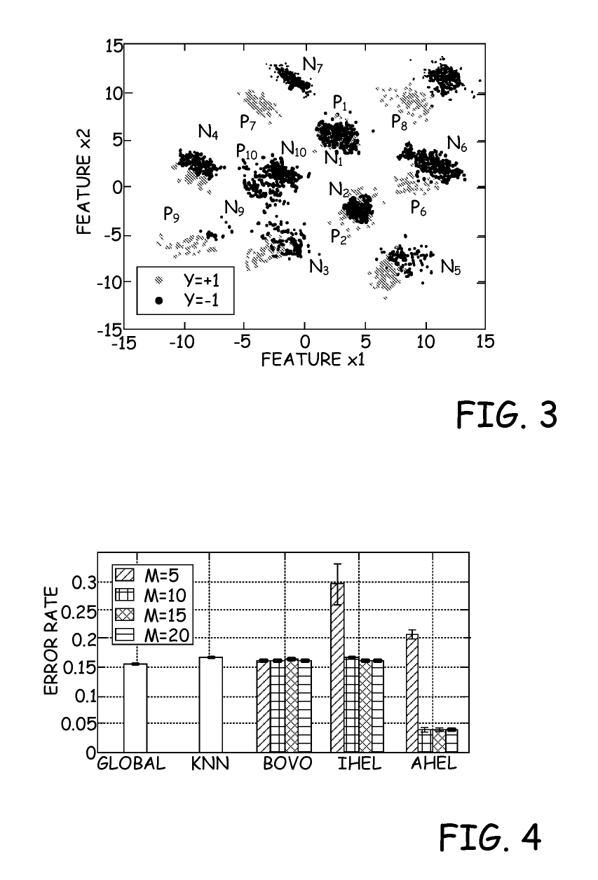

We considered the synthetic dataset shown in FIG. 3, which comprises of 10 positive and 10 negative modes, where every mode is generated using a bi-variate Gaussian distribution. Note that some pairs of modes in this dataset are easily separable (e.g. P₇ and N₇), while others show a high degree of class confusion (e.g. P₁ and N₁). These synthetic modes are representative of the variety of positive and negative modes that are experienced in real-world classification problems. We randomly sampled 200 instances each from every positive and negative mode for constructing the global training dataset. To simulate a variety of test scenarios, we randomly sampled 1000 instances each from every pair of positive and negative modes, Pᵢ and Nⱼ, to construct 100 test scenarios, S_{i,j}. The random sampling procedure for obtaining the training and test sets was repeated 10 times.

FIG. 4 compares the error rates of competing classification algorithms on the overall test set, comprising of instances from all possible 100 test scenarios. The bisecting K-means (BKM) algorithm was used as the preferred clustering strategy for BOVO, IHEL, and AHEL, with varying number of clusters, m. It can be seen that both GLOBAL and BOVO have error rates close to 0.15, since they are unable to incorporate the local context of test scenarios for overcoming class confusion. Furthermore, techniques that use instance-specific context of individual test instances, namely KNN and IHEL, show no significant improvement than GLOBAL. In contrast, AHEL shows a significant reduction in the error rate for m≧10 when compared with all the baseline approaches, since it uses the overall distribution of instances belonging to a test scenario for adapting its learning.

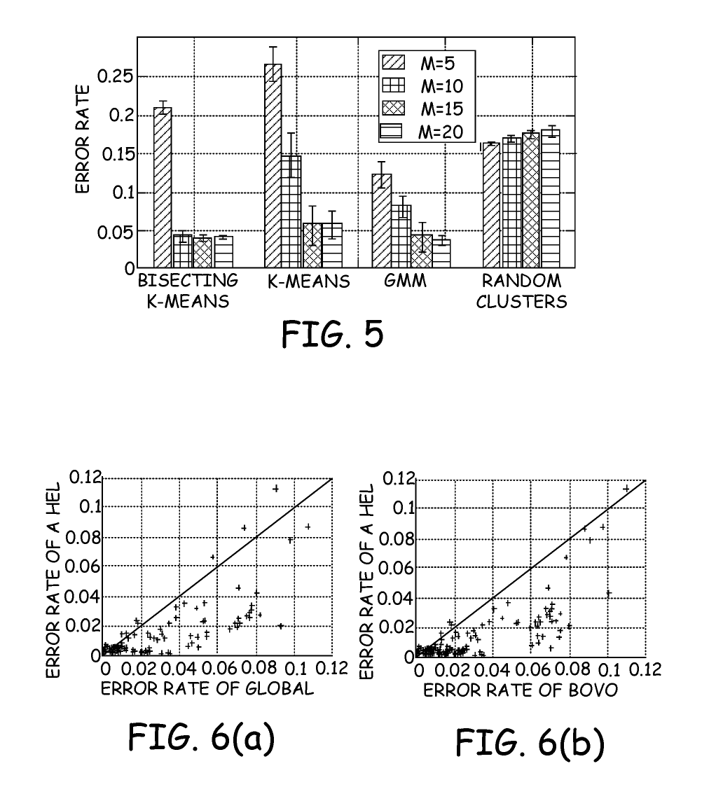

FIG. 5 compares the performance of AHEL using varying clustering algorithms and number of clusters (m) used to rep resent the multi-modality within the classes. It can be seen that the performance of AHEL is initially poor for m=5 because the clustering is unable to capture the heterogeneity within the classes, resulting in under-clustering, which degrades the performance of AHEL. However, as m is increased from 5 to 20, AHEL is able to adequately capture the heterogeneity within the classes and thus show drastic improvements in classification performance for all clustering algorithms. Note that the performance of AHEL using Bisecting K-means is better than that of AHEL using K-means and Gaussian Mixture Model (GMM) clustering for m≧10, due to the tendency of K-means and GMM clustering to merge larger clusters and thus exhibit under-clustering. However, the performance of AHEL does not deteriorate even in the presence of over-clustering as m is increased from 10 to 20. Instead, the variance of the error rates of AHEL keeps decreasing as m is increased beyond 10, demonstrating the robustness of AHEL even with a large number of ensemble classifiers. FIG. 5 also shows that the performance of AHEL is significantly better when a meaningful clustering strategy is used (e.g. BKM, K-means, and GMM), instead of using an artificial partitioning of the data into random clusters, demonstrating the utility of using information about the multi-modality within the two classes while learning classifier ensembles.

### B. Global Water Monitoring Results:

We consider a real-world application of AHEL for monitoring water bodies at a global scale using remote sensing variables. Monitoring water bodies is important for effective water management and for understanding the impact of human actions and climate change on water bodies. To this end, remote sensing variables capture a variety of information about the Earth's surface that can be used for labeling every location on the Earth at a given time as water or land (binary classes). However, the presence of a rich variety of land and water categories that exist at a global scale makes it challenging to perform global water monitoring. There is an opportunity to overcome this challenge by using the local context of a test scenario, involving test instances observed in the vicinity of the same water body at the same time-step.

We used the seven reflectance bands collected by the MODerate-resolution Imaging Spectoradiometer (MODIS) instruments onboard NASA's satellites as the set of features for classification, which are available at 500 m resolution for every 8 days. Ground truth information was obtained via the Shuttle Radar Topography Mission's (SRTM) Water Body Dataset (SWBD), which provides a mapping of all water bodies for a large fraction of the Earth (60° S to 60° N), but for a single date: Feb. 18, 2000. We considered a diverse set of 99 lakes collected from different regions of the world for the purpose of evaluation. For each lake, we created a buffer region of 20 pixels at 500 m resolution around the periphery of the water body, and used the buffer region as well as the interior of the water body to construct the evaluation dataset. After removing instances at the immediate boundaries of the water bodies and ignoring instances with missing values, this evaluation dataset comprised of ≈1.3 million data instances, where every instance had an associated binary label of water (positive) or land (negative). We randomly sampled 2000 instances each from both classes to construct the global training dataset. The remainder of the evaluation dataset was considered for testing. Since different pairs of water and land categories appear together in different regions of the world and at different times, we needed to consider test scenarios involving different pairs of water and land categories for the purpose of evaluation. To achieve this, we first clustered the water and land classes in the test set into m=15 clusters each using the Bisecting K-means clustering algorithm. Every pair of water and land clusters, (Wᵢ, Lⱼ), was then considered as a different test scenario, S_{i,j}. We repeated the sampling procedure for obtaining the training and test sets 10 times.

FIG. 6 presents scatter plots comparing the performance of AHEL with baseline approaches individually across all 225 test scenarios. Every point on a scatter plot compares the mean error rate of two classification algorithms on a particular test scenario, where the line in each scatter plot shows the plot of y=x for ease of comparison. It can be seen that AHEL shows drastic improvements in classification performance than GLOBAL and BOVO across a vast majority of test scenarios. In order to assess the statistical significance of the differences in the classification performance, we computed the p-value of AHEL showing lower mean error rate than GLOBAL and BOVO over all 225 test scenarios using one-tailed Wilcoxon signed rank tests, which came out to be equal to 1.74×10⁻²⁵ and 2.02×10⁻³⁵ respectively. This shows that the improvements in classification performance of AHEL are statistically significant.

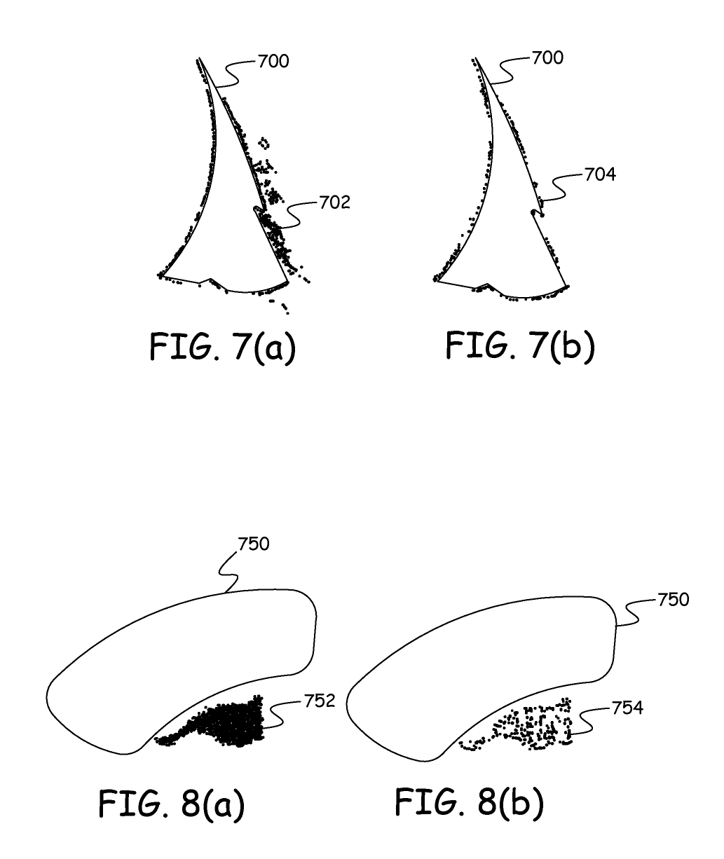

We next analyze the differences in the performance of AHEL and baseline approaches over two illustrative test scenarios, S_{5,1} and S_{10,1}. FIGS. 7(a) and 7(b) show pixel classification errors for an image of Curonian Lagoon in Russia where FIG. 7(a) shows the classification performance of GLOBAL and FIG. 7(b) shows the classification performance of AHEL on the test scenario S_{5,1} involving W₅ and L₁. In FIGS. 7(a) and 7(b) In the images, the Lagoon 700 is surrounded by land a portion of which is from the land category L₁. For these instances belonging to category L₁, FIGS. 7(a) and 7(b) show the misclassifications (errors) of GLOBAL and AHEL respectively as pixels 702 and 704, respectively. It can be observed that GLOBAL is making errors over a large portion of L₁ as compared to AHEL. This is because L₁ comprises of land instances that appear very close to shallow water, resulting in its class confusion in the global training set. However, in the local context of S_{5,1}, AHEL is able to handle the class confusion and thus show improved classification performance. The mean error rates of GLOBAL and AHEL for S_{5,1} are 0.081 and 0.027 respectively. FIGS. 8(a) and 8(b) present a similar analysis of the performance of BOVO and AHEL for the test scenario S_{10,1} using an image of Burullus Lake, Egypt. The mean error rates of BOVO and AHEL for S_{10,1} are 0.07 and 0.019 respectively. FIG. 8(a) shows classification errors 752 resulting from BOVO classification of the land around Burullus Lake 750 while FIG. 8(b) shows classification errors 754 resulting from AHEL classification of the land around Burullus Lake 750.

### System

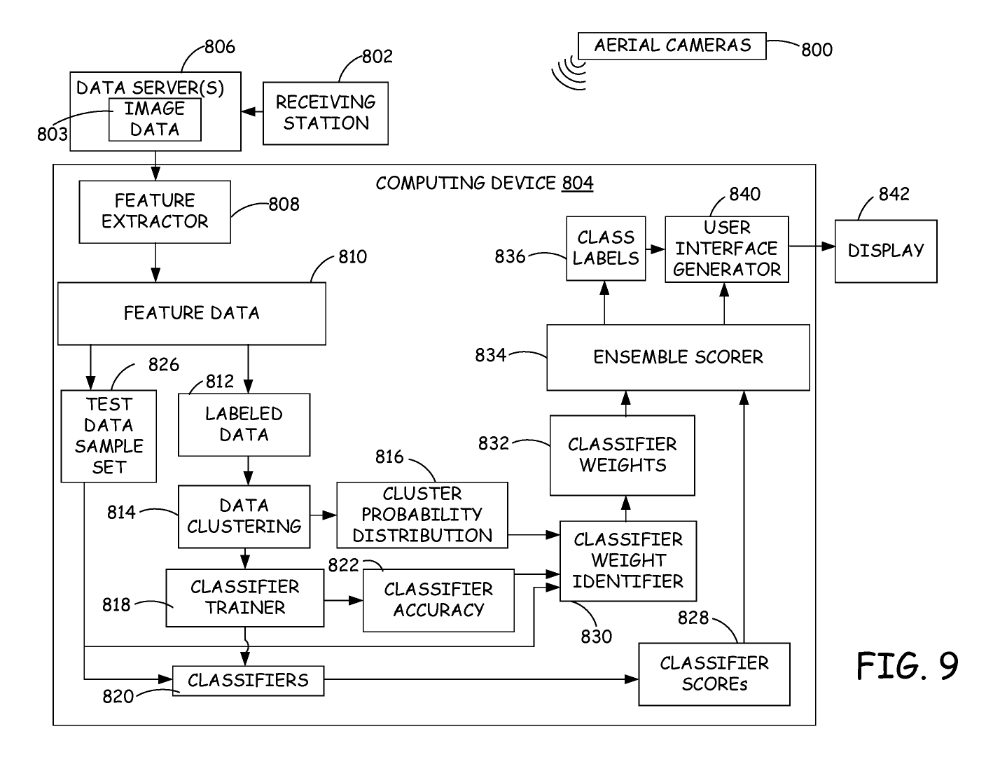

FIG. 9 provides a block diagram of a system in accordance with one embodiment. Aerial cameras 800 capture images of multiple geographic areas on earth. The aerial cameras can include one or more sensors for each pixel and thus each pixel can be represented by a plurality of sensor values for each image captured by aerial cameras 800. The sensor data produced by aerial cameras 800 is sent to a receiving station 802, which stores the sensor data as image data 803 in data servers 806.

A processor in a computing device 804 executes instructions to implement a feature extractor 808 that retrieves image data 803 from the memory of data servers 806 and identifies features from the image data 803 to produce feature data 810 for each pixel in each image. Feature extractor 808 can form the feature data 810 by using the image data 803 directly or by applying one or more digital processes to image data 803 to alter the color balance, contrast, and brightness and to remove some noise from image data 803. Other digital image processes may also be applied when forming feature data 810. In addition, feature extractor 808 can extract features such that the resulting feature space enhances the ability to identify land cover types.

Experts review some of the feature data of feature data 810 and label the feature data to form label data 812. Label data 812 includes a feature vector for a pixel and a land cover class that the pixel belongs to. In accordance with one embodiment, binary class assignments are used such that each pixel is either labeled as water or land. Labeled data 812 is provided to a data clustering algorithm 814 as described above. Data clustering algorithm 814 first divides labeled data 812 based on the labels applied to the feature vectors. For each label (e.g. water or land), data clustering algorithm 814 groups the feature vectors into clusters based on the similarities between the feature vectors. Thus, the feature vectors labeled as being water are clustered separately from feature vectors labeled as being land. Data clustering algorithm 814 also produces cluster probability distribution 816 that can be used to determine the probability of any feature vector being part of the cluster as described above.

The data clusters formed by data clustering algorithm 814 are provided to a classifier trainer 818, which trains a plurality of classifiers 820 from the data clusters. In particular, a separate classifier is trained for each possible pairing of a cluster with a water label and a cluster with a land label. For example, if there were five water clusters and six land clusters, thirty classifiers would be trained. When training a classifier for a pairing of a water cluster and a land cluster, the classifier is trained to discriminate the feature vectors of the water cluster from the feature vectors of the land cluster. Classifier trainer 818 also determines the cross-validation accuracy 822 of each classifier 820.

A test data sample set 826 is selected from feature data 810 and is applied to each of the classifiers 820 to generate a respective classifier score 828 that is indicative of which class, water or land, the classifier identifies as being more likely for the particular feature vector. Each feature vector of the test data sample set 826 is also provided to a classifier weight identifier 830, which also receives classifier accuracy 822 and cluster probability distribution 816. Classifier weight identifier 830 uses the equations described above to determine a weight 832 for each classifier. Each classifier weight 832 is based on the entire test data sample set 826 as discussed above. Ensemble scorer 834 receives the classifier weights 832 and the classifier scores 828 and combines the scores and the classifier weights to form class labels 836 for each of the pixels in test data sample set 826 as discussed above.

Class labels 836 can be used by a user interface generator 840 implemented by a processor to generate a user interface on a display 842. In accordance with one embodiment, the user interface produced by user interface generator 840 comprises a color-coded image indicating the land cover state of each pixel. Using the color coding, the land cover state of each pixel in an image can be quickly conveyed to the user through the user interface on display 842. Alternatively, user interface generator 840 may generate statistics indicating the number or percentage of each land cover state in each image or across multiple image areas. These statistics can be displayed to the user through a user interface on display 842.

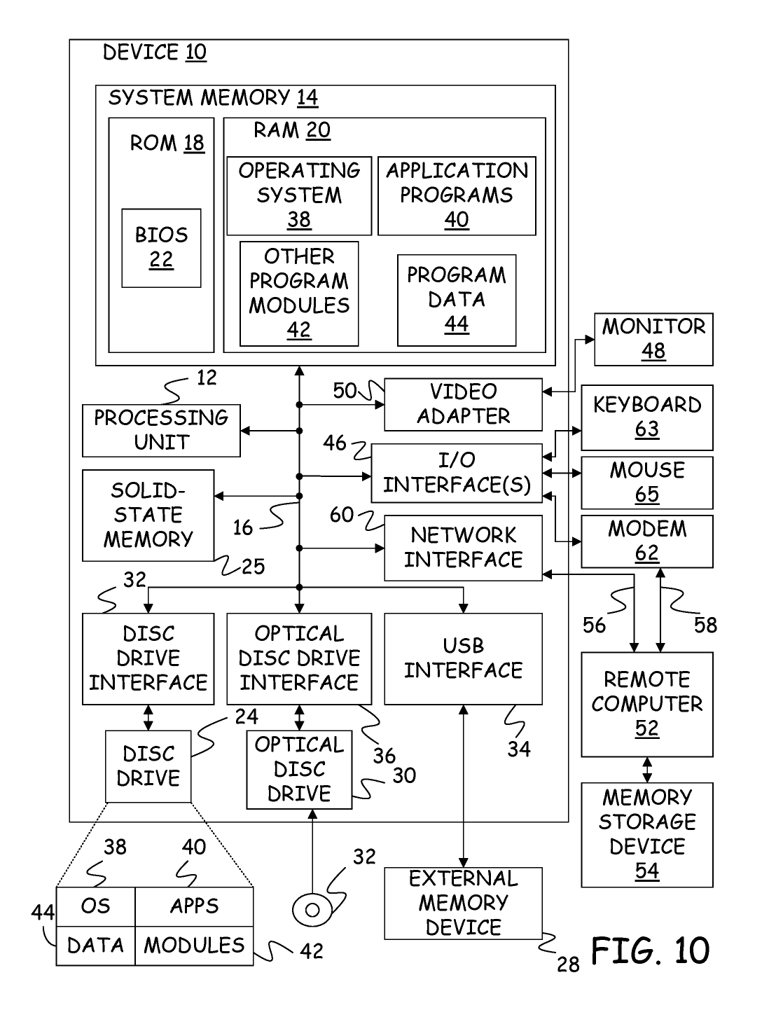

An example of a computing device that can be used as computing device 804, data server 806, and receiving station 802 in the various embodiments is shown in the block diagram of FIG. 10. The computing device 10 of FIG. 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable storage media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for executing the methods described above including feature extraction, data clustering, classifier training, classifier execution, classifier weight identification, ensemble scoring and user interface generation. Program data 44 may include image data, feature data, class labels, cluster probability functions, classifier accuracy, classifier weights, labeled data, classifier scores and class labels.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 10. The network connections depicted in FIG. 10 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program, such as data stored in the databases or lists described above, may illustratively be stored within memory storage device 54. It will be appreciated that the network connections shown in FIG. 10 are exemplary and other means for establishing a communications link between the computers, such as a wireless interface communications link, may be used.

### CONCLUSION

We consider binary classification problems where both classes show a multi-modal distribution in the feature space and the classification has to be performed over different test scenarios, where every test scenario involves only a subset of all the positive and negative modes in the data. We propose the Adaptive Heterogeneous Ensemble Learning (AHEL) algorithm that constructs an ensemble of classifiers to discriminate between every pair of positive and negative modes, and uses the local context of test scenarios for adaptively weighting the ensemble of classifiers. We demonstrate the effectiveness of AHEL in comparison with baseline approaches on a synthetic dataset and a real-world application involving global water monitoring.

Although the present invention has been described with reference to preferred embodiments, workers skilled in the art will recognize that changes may be made in form and detail without departing from the spirit and scope of the invention.

What is claimed is:

1. A system comprising:
an aerial image database containing sensor data representing an aerial image of the earth surface, the sensor data comprising a feature vector for each pixel in the aerial image;
a processor applying a plurality of classifiers to each feature vector to produce a plurality of classifier scores for each feature vector;
the processor determining a plurality of cluster probabilities for each feature vector, each cluster probability for a feature vector indicating a probability of the feature vector given a respective cluster of feature vectors;
the processor using the cluster probabilities for the feature vectors to form a respective weight for each of the plurality of classifiers; and
the processor combining the weights and the classifier scores to form an ensemble score for each pixel, the ensemble score indicating which of two possible land cover types is present on a portion of the earth surface represented by the pixel.

2. The system of claim 1 wherein each classifier has been trained to discriminate between a respective first cluster of feature vectors that have been labeled as being from a first of the two possible land cover types and a respective second cluster of feature vectors that have been labeled as being from a second of the two possible land cover types.

3. The system of claim 2 wherein using the cluster probabilities to form a weight for a classifier comprises:
identifying the two clusters that the classifier was trained to discriminate between;
for each of the two clusters, determining a sum of the cluster probabilities of each feature vector given the cluster;
multiplying the two sums of the cluster probabilities to form a relevance score for the classifier; and
using the relevance score to form the weight for the classifier.

4. The system of claim 3 wherein using the cluster probabilities to form a weight for the classifier further comprises multiplying the relevance score by an accuracy measure of the classifier to form the weight.

5. The system of claim 1 further comprising using the ensemble scores to generate a user interface indicating the land cover type at each pixel.

6. The system of claim 1 further comprising a clustering algorithm that clusters feature vectors of labeled data to form the plurality of clusters and a respective probability distribution for each cluster.

7. The system of claim 1 wherein the ensemble score improves the ability of the processor to predict which of the two land cover types a pixel represents.

8. A method comprising:
retrieving from memory, features for a set of pixels, each pixel representing an image of a geographic area;
classifying each pixel's features using a plurality of different classifiers to generate a plurality of classifier scores for each pixel's features;
determining a weight for each classifier score for each pixel based on similarities between the pixel's features and features used to train the respective classifier that generated the classifier score;
applying each weight to the weight's respective classifier score to form a weighted score and combining the weighted scores to determine an ensemble score for each pixel; and
using the ensemble score for each pixel to designated the geographic area represented by the pixel as being one of two land cover types.

9. The method of claim 8 wherein each classifier is trained to discriminate between two respective clusters of features, with one cluster of features labeled as coming from one of the two land cover types and the other cluster of features labeled as coming from the other of the two land cover types.

10. The method of claim 9 wherein determining a weight for a classifier score comprises determining a separate relevance score for each cluster that the classifier is trained to discriminate between based on the pixel's features and using the relevance scores to determine the weight for the classifier score.

11. The method of claim 10 wherein each relevance score comprises a probability of the pixel's feature given a cluster.

12. The method of claim 11 wherein determining a weight for a classifier score further comprises combining the relevance scores with an accuracy measure for the classifier that generated the classifier score.

13. The method of claim 9 wherein the two land cover types are land and water.

14. The method of claim 8 further comprising generating a user interface that displays the land cover type of each pixel in an image.

15. A computer-readable storage device having stored thereon computer-executable instructions that when executed by a processor cause the processor to perform steps comprising:
for each pixel in an image of a geographic area, determining a plurality of classifier scores, each classifier score indicative of whether the pixel represents a first land cover type or a second land cover type;
weighting each classifier score based on a relevance score of a classifier that generated the classifier score, the relevance score indicating the likelihood that the pixel would be part of clusters of pixels that the classifier was trained to discriminate between; and
using the weighted classifier scores to produce an ensemble score that is indicative of whether the pixel represents the first land cover type or the second land cover type.

16. The computer-readable storage device of claim 15 the relevance score for a classifier comprises a product of a probability of the pixel given a first cluster of pixels and a probability of the pixel given a second cluster of pixels.

17. The computer-readable storage device of claim 16 wherein the first cluster of pixels are pixels labeled as representing water and the second cluster of pixels are pixels labeled as representing land.

18. The computer-readable storage device of claim 16 wherein weighting each classifier score based on the relevance score comprises multiplying the relevance score by an accuracy measure of the classifier to form a weight and multiplying the classifier score by the weight.

19. The computer-readable storage device of claim 18 wherein the accuracy measure of the classifier is set to zero if the accuracy measure is below a threshold value.

20. The computer-readable storage device of claim 15 wherein the processor performs further steps comprising generating a user interface that displays the land cover type of each pixel.
